(19) United States
(12) Patent Application Publication
(10) Pub. No.: US 2026/0046036 A1
(43) Pub. Date: Feb. 12, 2026

(54) OPTICAL POWER SUPPLY METHOD AND OPTICAL POWER SUPPLY SYSTEM

(71) Applicant: NTT, Inc., Tokyo (JP)

(72) Inventors: Ryo Miyatake, Musashino-shi, Tokyo (JP); Yoichi Fukada, Musashino-shi, Tokyo (JP); Hiroaki KATSURAI, Musashino-shi, Tokyo (JP); Kenta ITO, Musashino-shi, Tokyo (JP); Ryota KITA, Musashino-shi, Tokyo (JP); Masayoshi SEKIGUCHI, Musashino-shi, Tokyo (JP); Tomoaki YOSHIDA, Musashino-shi, Tokyo (JP)

(21) Appl. No.: 19/101,287

(22) PCT Filed: Sep. 13, 2022
(86) PCT No.: PCT/JP2022/034144

§ 371 Date: Feb. 5, 2025

(51) Int. Cl. H04B 10/80

(52) U.S. Cl. CPC H04B 10/807

(57) ABSTRACT

An optical power supply method includes: a step of transmitting, by a light source, light for optical power supply to an optical power supply line connected to an optical power supply unit; a step of amplifying, by an amplifier installed in the middle of a path of the optical power supply line, the light transmitted from the light source; and a step of receiving, by the optical power supply unit, the light amplified by the amplifier, and photoelectrically converting the light to obtain power.

### TECHNICAL FIELD

The present invention relates to an optical power supply method and an optical power supply system.

### BACKGROUND ART

Techniques exist to enhance the amount of power supplied using optical power supply in order to drive devices at the light-receiving end for a long period of time. The devices at the light-receiving end referred to here are electronic devices, such as Internet of things (IoT) devices, installed in, for example, deep forests, underground, inside earthen pipes or manholes, or other locations. The surrounding environment of such devices are assumed to be, for example, challenging for energy harvesting from sunlight or the like, or to be outside cell phone communication areas. In addition, the installation location of the device is assumed to be far from the light source of the optical power supply.

FIG. 15 is a diagram illustrating an example of a configuration of an optical power supply system using a conventional optical power supply method. As illustrated in FIG. 15, in the conventional optical power supply method, light is transmitted from a light source provided in a shelter building or the like to an optical power supply unit installed in a power supply target area, which is a non-electrified area, for example, through an optical power supply line using an optical fiber. As the network configuration of the optical power supply line, for example, a single-star (SS) configuration without branching is used to reduce branching loss. In the power supply target area, light transmitted via the optical power supply line is received by the photodiode (PD) of the optical power supply unit. The received light is converted into an electric signal, and power is supplied to the power supply target device in the power supply target area.

### CITATION LIST

### Non Patent Literature

Non Patent Literature 1: Ryota Kita, Yoichi Fukada, Hiroaki Katsurai, Tomoaki Yoshida, “Optical Power Supply Unit for IoT Terminal, and Power-Balance Evaluation under Intermittent Operation”, The Institute of Electronics, Information and Communication Engineers (IEICE) General Conference, B-8-12, March 2022
Non Patent Literature 2: Keiji Takeuchi, “Spotlight Special: Energy Harvesting “Emerging Trends in Energy Harvesting Technologies”, Journal of the Surface Finishing Society of Japan, Vol. 17, No. 7, pp. 334-338, NTT DATA INSTITUTE OF MANAGEMENT CONSULTING, INC, 2016, [searched on Aug. 30, 2022], Internet (URL: https://www.jstage.jst.go.jp/article/sfj/67/7/67_334/pdf/-char/ja)

### SUMMARY OF INVENTION

### Technical Problem

However, in the conventional optical power supply methods, the amount of power supplied is smaller compared to general power supply methods that use, for example, commercial power supplies and metal wires. FIG. 16 is a schematic diagram illustrating the amount of power supplied by the optical power supply system using the conventional optical power supply method. As illustrated in FIG. 16, in the conventional optical power supply method, the longer the distance between the light source and the optical power supply unit, the greater the optical fiber loss that occurs in the optical power supply line, resulting in a smaller amount of power supplied. Therefore, in the conventional optical power supply method, when the distance between the light source and the optical power supply unit is long, it may not be feasible to supply sufficient power to operate the device in the power supply target area. To deal with this, for example, a method to increase the amount of power supplied by increasing the amount of light of the light source is conceivable, but in this case, the optical fiber may overheat due to, for example, a fiber fuse phenomenon or the like, leading to deterioration in safety, which has been problematic.

The present invention has been made in view of the technical background as described above, and an object of the present invention is to provide a technique capable of increasing the amount of power supplied without compromising safety in optical power supply.

### Solution to Problem

An aspect of the present invention is an optical power supply method including: a step of transmitting, by a light source, light for optical power supply to an optical power supply line connected to an optical power supply unit; a step of amplifying, by an amplifier installed in the middle of a path of the optical power supply line, the light transmitted from the light source; and a step of receiving, by the optical power supply unit, the light amplified by the amplifier, and photoelectrically converting the light to obtain power.

An aspect of the present invention is an optical power supply system including: a light source that transmits light for optical power supply to an optical power supply line connected to an optical power supply unit; an amplifier that is installed in the middle of a path of the optical power supply line and amplifies light transmitted from the light source; and the optical power supply unit that receives the light amplified by the amplifier and photoelectrically converts the light to obtain power.

### Advantageous Effects of Invention

According to the present invention, it is possible to enhance the amount of power supplied without compromising safety in optical power supply.

### BRIEF DESCRIPTION OF DRAWINGS

FIG. 1 is an overall configuration diagram of an optical power supply system 1 according to a first embodiment of the present invention.

FIG. 2 is a schematic diagram illustrating the amount of energy within an optical fiber according to the optical power supply system 1 according to the first embodiment of the present invention.

FIG. 3 is an overall configuration diagram of an optical power supply system 1a according to a second embodiment of the present invention.

FIG. 4 is an overall configuration diagram of an optical power supply system 1b according to a third embodiment of the present invention.

FIG. 5 is a flowchart illustrating an operation of a switch control unit 42 of the optical power supply system 1b according to a third embodiment of the present invention.

FIG. 6 is an overall configuration diagram of an optical power supply system 1c according to a fourth embodiment of the present invention.

FIG. 7 is a diagram illustrating an overall configuration of an optical power supply system 1d according to a fifth embodiment of the present invention and the amount of energy within an optical fiber.

FIG. 8 is an overall configuration diagram of an optical power supply system 1e according to a sixth embodiment of the present invention.

FIG. 9 is a flowchart illustrating the operation of the optical power supply system 1e according to the sixth embodiment of the present invention.

FIG. 10 is an overall configuration diagram of an optical power supply system 1f according to a seventh embodiment of the present invention.

FIG. 11 is an overall configuration diagram of an optical power supply system 1g according to an eighth embodiment of the present invention.

FIG. 12 is a diagram illustrating an example of the present invention.

FIG. 13 is a diagram illustrating an example of the introduction of the optical power supply system according to the embodiments of the present invention.

FIG. 14 is a diagram illustrating an example of the introduction of the optical power supply system according to the embodiments of the present invention.

FIG. 15 is a diagram illustrating an example of a configuration of an optical power supply system according to a conventional optical power supply method.

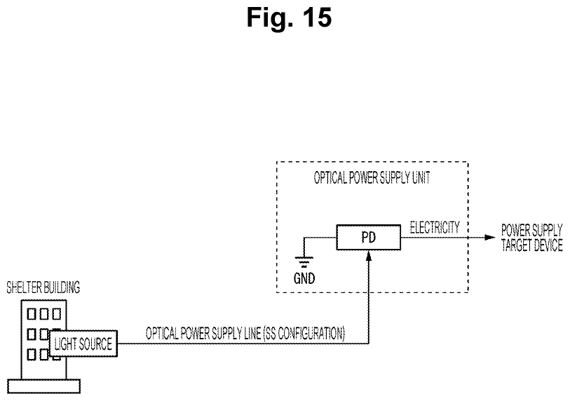

FIG. 16 is a schematic diagram illustrating the amount of power supplied by an optical power supply system using a conventional optical power supply method.

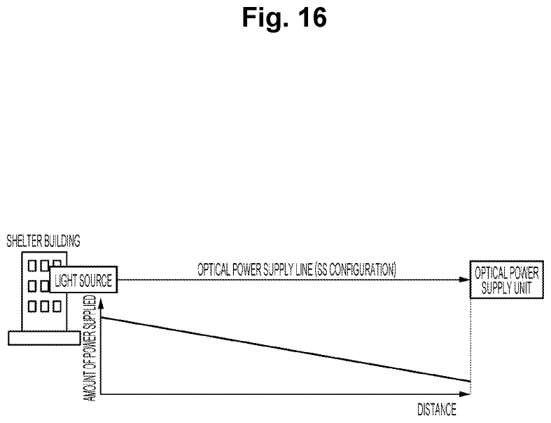

### DESCRIPTION OF EMBODIMENTS

Hereinafter, an optical power supply method and an optical power supply system according to an embodiment will be described with reference to the drawings.

### First Embodiment

A first embodiment of the present invention will be described below.

### [Configuration of Optical Power Supply System]

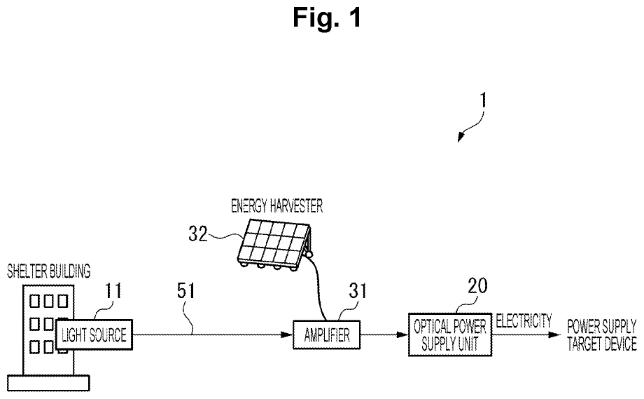

In the following, a configuration of the optical power supply system 1 according to the first embodiment will be described. FIG. 1 is the overall configuration diagram of the optical power supply system 1 according to a first embodiment of the present invention. The optical power supply system 1 is a system for supplying power to a device (hereinafter referred to as a “power supply target device”) that exists in a power supply target area using optical power supply. The power supply target area in the present embodiment is, for example, a non-electrified area.

The power supply target device is an electronic device, such as an IoT device, installed in, for example, a deep forest, underground, inside an earthen pipe or manhole, or other locations. The surrounding environment of such devices are assumed to be, for example, challenging for energy harvesting from sunlight or the like, or to be outside cell phone communication areas. In addition, the installation location of the device is assumed to be far from the light source of the optical power supply. As illustrated in FIG. 1, the optical power supply system 1 includes a light source 11, an optical power supply unit 20, an amplifier 31, an energy harvester 32, and an optical power supply line 51.

The light source 11 is installed, for example, in a building such as a shelter building of a communication base station. This shelter building is located in an electrified area, for example, located far away from the power supply target area. The light source 11 emits light for optical power supply and transmits the light to the optical power supply line 51. For example, a continuously illuminated light source may be used for optical power supply. The light transmitted by the light source 11 is transmitted to the optical power supply unit 20 via the optical power supply line 51. The optical power supply line 51 is configured using an optical fiber. For the network configuration of the optical power supply line 51, for example, a single-star (SS) configuration without branching is used with the purpose of reducing branching loss.

The optical power supply unit 20 is installed, for example, inside or near the power supply target area. The optical power supply unit 20 includes, for example, a photodiode (PD) (not illustrated). The light transmitted by the light source 11 is received by the PD of the optical power supply unit 20. The optical power supply unit 20 converts the received light into an electric signal and supplies power to the power supply target device.

The amplifier 31 is an optical amplifier that replenishes (amplifies) the energy lost due to optical fiber loss in optical transmission in the optical power supply line 51. In the present embodiment, the amplifier 31 is located, for example, in a non-electrified area and is driven by power harvested by the energy harvester 32.

As the energy harvester 32, for example, devices using various energy harvesting technologies described in Non Patent Literature 2 can be used. The various energy harvesting technologies are, for example, technologies for obtaining power using solar power harvesting (solar cell), a piezoelectric effect, or electromagnetic induction. That is, the harvesting technologies are technologies for harvesting and converting dilute energy existing in various forms in the ambient surroundings, such as light, vibration, heat, and radio waves, into power. Using the energy harvester 32 enables the installation of the amplifier 31 in the non-electrified area.

In addition, the amount of energy replenished by the amplifier 31 is determined in further consideration of the amplifier connection loss caused by the connection of the amplifier 31 to the optical power supply line 51 as well as the optical fiber loss described above. The installation location of the amplifier 31 is also determined in further consideration of the amplifier connection loss. The amount of power harvested by the energy harvester 32 is determined according to the amount of energy required to be replenished by the amplifier 31.

### [Determination of Energy Amplification Amount]

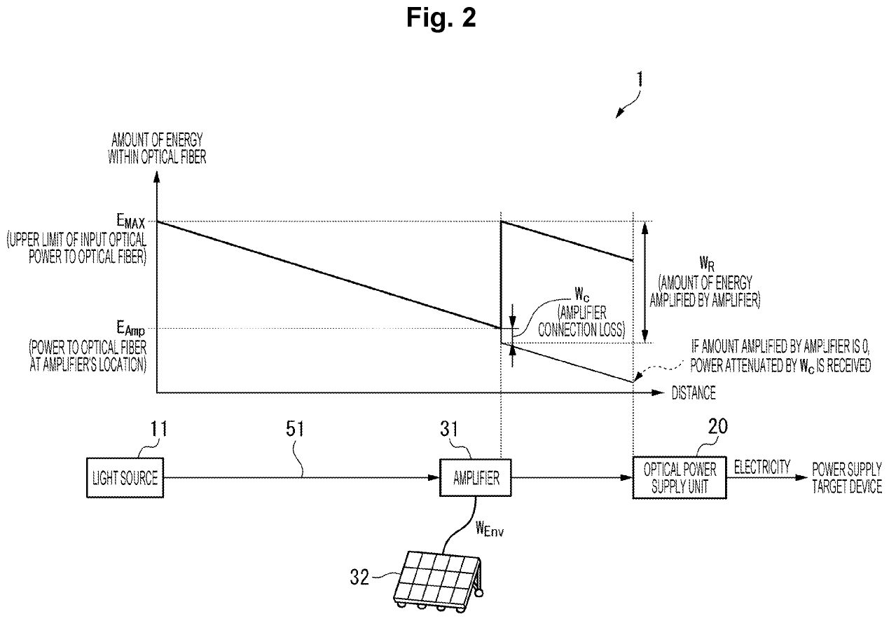

Hereinafter, a method for determining the amount of energy required to be replenished by the amplifier 31, by the optical power supply system 1 according to the first embodiment will be described. FIG. 2 is a schematic diagram illustrating the amount of energy within an optical fiber according to the optical power supply system 1 according to the first embodiment of the present invention.

In FIG. 2, E_{MAX} represents an upper limit of power (input optical power) that can be input to the optical fiber. E_{Amp} represents the power of the optical fiber at the location of the amplifier 31. W_{C} represents an amplifier connection loss caused by connecting the amplifier 31 to the optical power supply line 51. W_{R} represents the amount of energy to be amplified by the amplifier 31. Here, the value of W_{R} is set to satisfy both the following conditions (a) and (b).

(a) From the viewpoint of safety, the amount of energy after amplification is an amount not exceeding the upper limit (E_{MAX}) of the power that can be input to the optical fiber.

(b) To obtain the energy amplification effect using the amplifier 31, the value of W_{R} is equal to or greater than the value of the amplifier connection loss (W_{C}) generated by connecting the amplifier 31 to the optical power supply line 51.

W_{R} satisfying the conditions (a) and (b) can be expressed as the following expression (1).

$${W}_{C} \leq {W}_{R} \leq ( {E}_{MAX} - {E}_{Amp} + {W}_{C} ) \qquad ( 1 )$$

As illustrated in FIG. 2, if the amount of energy amplified by the amplifier 31 is zero, the power received at the optical power supply unit 20 (light-receiving end) has a value attenuated by the amplifier connection loss (W_{C}) in addition to the optical fiber loss, which depends on the distance from the light source 11

In FIG. 2, W_{Env} represents the amount of power harvested by the energy harvester 32. Here, when the conversion efficiency from electricity to light by the amplifier 31 is A [%], the installation location and size of the energy harvester 32 are determined so that the value of [W_{Env}×A/100] is equal to or greater than W_{R}.

The size of the energy harvester 32 referred to here means, for example, the size, number, and the like of panels when the energy harvester 32 is a solar power harvester. If the value of [W_{Env}×A/100] can be set to equal to or greater than W_{R}, then the value may be appropriately attenuated so that the amount of energy amplified by the amplifier 31 is equal to W_{R}, using, for example, an attenuator (ATT) or the like.

As described above, in the optical power supply system 1 according to the first embodiment, the amplifier 31 is provided in the middle of the path of the optical power supply line 51, which is an optical transmission line connecting the light source 11 and the optical power supply unit 20 that supplies power to the power supply target device. The amplifier 31 amplifies energy to replenish the amount of energy corresponding to the optical fiber loss that occurs in the optical power supply line 51. With such a configuration, the optical power supply system 1 according to the first embodiment can supply sufficient power to operate the device in the power supply target area even if, for example, the distance between the light source 11 and the optical power supply unit 20 is long, and the optical fiber loss that occurs in the optical power supply line 51 is large.

As described above, in the optical power supply system 1 according to the first embodiment, the amplifier 31 further amplifies energy in further consideration of the amplifier connection loss caused by the connection of the amplifier 31 to the optical power supply line 51. With such a configuration, the optical power supply system 1 according to the first embodiment can supply sufficient power to operate the device in the power supply target area even if the amplifier connection loss occurs.

As described above, in the optical power supply system 1 according to the first embodiment, the amplifier 31 is driven by the power harvested by the energy harvester 32. With such a configuration, according to the optical power supply system 1 of the first embodiment, not only the power supply target device and the optical power supply unit 20 but also the amplifier 31 can be installed in the non-electrified area.

In addition, in the optical power supply system 1 according to the first embodiment, since it is not necessary to increase the amount of light of the existing light source 11 to enhance the amount of power supplied, the heating of the optical fiber or the like does not occur. Therefore, the optical power supply system 1 according to the first embodiment can enhance the amount of power supplied without compromising safety in optical power supply.

In addition, in the optical power supply system 1 according to the first embodiment, the PDs of the existing light source 11, the existing optical power supply line 51, and the existing optical power supply unit 20 can be utilized. As described above, since the optical power supply system 1 according to the first embodiment can be constructed without significantly modifying the existing system, the installation cost can be kept low.

### Second Embodiment

A second embodiment of the present invention will be described below.

### [Configuration of Optical Power Supply System]

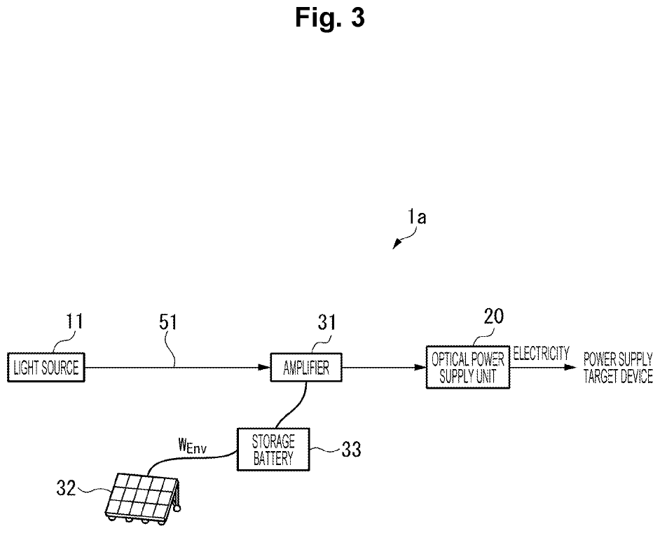

In the following, a configuration of an optical power supply system 1a according to a second embodiment will be described. FIG. 3 is the overall configuration diagram of an optical power supply system 1a according to a second embodiment of the present invention. As illustrated in FIG. 3, the optical power supply system 1a includes a light source 11, an optical power supply unit 20, an amplifier 31, an energy harvester 32, a storage battery 33, and an optical power supply line 51.

The configuration of the optical power supply system 1a according to the second embodiment differs from the configuration of the optical power supply system 1 according to the first embodiment described above in that the storage battery 33 is installed in the middle of the path between the amplifier 31 and the energy harvester 32. The storage battery 33 stores electricity harvested by the energy harvester 32. The storage battery 33 supplies the stored power to the amplifier 31.

Similarly to FIG. 2, in FIG. 3 as well, W_{Env} represents the amount of power harvested by the energy harvester 32. Here, when the conversion efficiency from electricity to light of the amplifier 31 is A [%] and the conversion efficiency of the storage battery is B [%], the installation location and size of the energy harvester 32 are determined so that the value of [W_{Env}×A/100×B/100] is equal to or greater than W_{R}. If the value of [W_{Env}×A/100×B/100] can be greater than or equal to W_{R}, then the output of the storage battery may be adjusted so that the amount of energy amplified by the amplifier 31 is equal to W_{R}.

As described above, in the optical power supply system 1a according to the second embodiment, the storage battery 33 is installed in the middle of the path between the amplifier 31 and the energy harvester 32. With such a configuration, the optical power supply system 1a according to the second embodiment can more stably supply power to the amplifier 31 compared to the case where the amplifier 31 and the energy harvester 32 are directly connected as in the optical power supply system 1 according to the first embodiment described above.

This is because, for example, the amount of power harvested by the energy harvester 32 is easily affected by the change in the environment, just as, for example, the amount of power harvested by the solar power harvester is easily affected by the change in the sunshine state. The installation of the storage battery 33 in the middle of the path between the amplifier 31 and the energy harvester 32 makes it possible to maintain the amount of energy supplied from the storage battery 33 to the amplifier 31 can substantially constant, even if the amount of power harvested by the energy harvester 32 becomes unstable due to the influence of environmental changes.

### Third Embodiment

A third embodiment of the present invention will be described below.

### [Configuration of Optical Power Supply System]

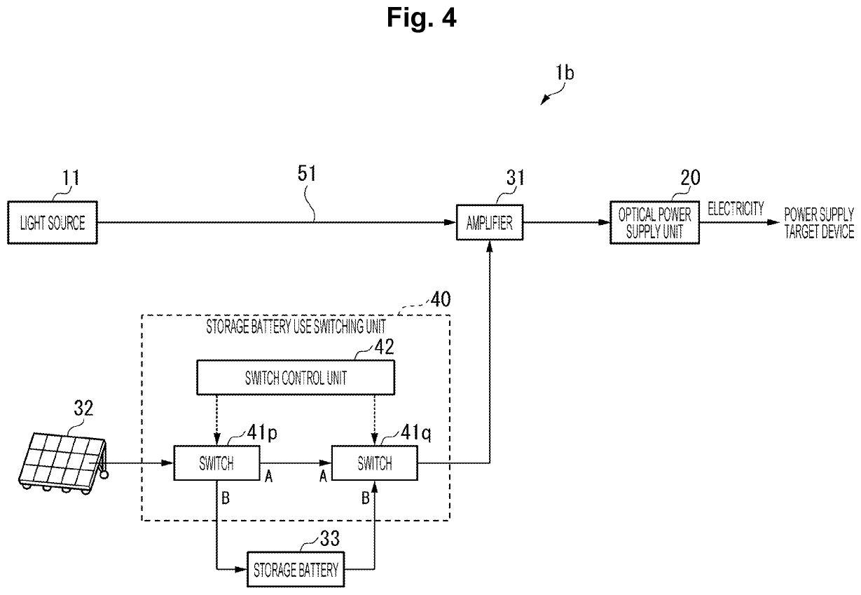

In the following, a configuration of an optical power supply system 1b according to the third embodiment will be described. FIG. 4 is the overall configuration diagram of an optical power supply system 1b according to a third embodiment of the present invention. As illustrated in FIG. 4, the optical power supply system 1b includes a light source 11, an optical power supply unit 20, an amplifier 31, an energy harvester 32, a storage battery 33, a storage battery use switching unit 40, and an optical power supply line 51.

The configuration of the optical power supply system 1b according to the third embodiment differs from the configuration of the optical power supply system 1a according to the second embodiment described above in that the storage battery use switching unit 40 (first switching unit) is installed between the amplifier 31 and the energy harvester 32. As illustrated in FIG. 4, the storage battery use switching unit 40 includes a switch 41p, a switch 41q, and a switch control unit 42.

The switch 41p is a one-input, two-output switch and can appropriately switch an output terminal to be used out of the two output terminals. On the other hand, the switch 41q is installed at a subsequent stage of the switch 41p. The switch 41q is a two-input, one-output switch and can appropriately switch an input terminal to be used out of the two input terminals. The switch control unit 42 controls the switching of terminals by the switch 41p and the switch 41q according to the amount of power harvested by the energy harvester 32.

As illustrated in FIG. 4, when the output of the switch 41p is switched to the A side, and the input of the switch 41q is switched to the A side, the path directly connects the energy harvester 32 and the amplifier 31. That is, the power harvested by the energy harvester 32 is directly input to the amplifier 31. When the output of the switch 41p is switched to the B side, and the input of the switch 41q is switched to the B side, the path connects the energy harvester 32 and the amplifier 31 through the storage battery 33. That is, the power harvested by the energy harvester 32 is temporarily stored in the storage battery 33, and then supplied from the storage battery 33 to the amplifier 31.

When the amount of power harvested by the energy harvester 32 exceeds the amount of power required in the amplifier 31, and there is surplus power, the switch control unit 42 controls the switch 41p and the switch 41q so that power is supplied from the storage battery 33 to the amplifier 31 while storing power in the storage battery 33. That is, in this case, the switch control unit 42 performs control so that both the output of the switch 41p and the input of the switch 41q are on the B side.

On the other hand, when the amount of power harvested by the energy harvester 32 does not exceed the amount of power required in the amplifier 31, and there is no surplus power, the switch control unit 42 controls the switch 41p and the switch 41q so that power is directly supplied from the energy harvester 32 to the amplifier 31. That is, in this case, the switch control unit 42 performs control so that both the output of the switch 41p and the input of the switch 41q are on the A side.

### [Operation of Switch Control Unit]

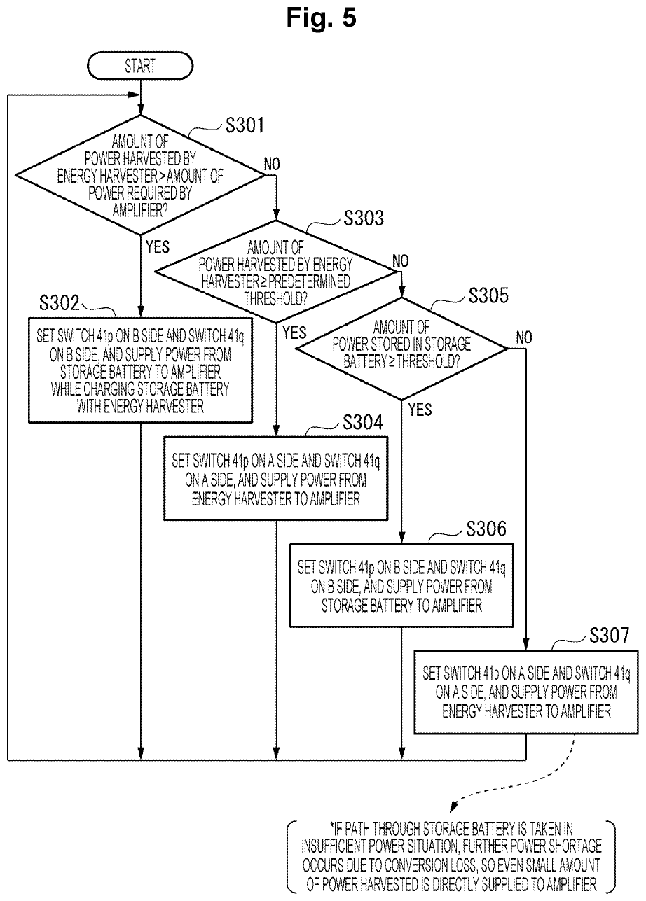

Hereinafter, the operation of the switch control unit 42 will be described. FIG. 5 is a flowchart illustrating the operation of the switch control unit 42 of the optical power supply system 1b according to the third embodiment of the present invention.

The switch control unit 42 compares the amount of power harvested by the energy harvester 32 with the amount of power required by the amplifier 31 (step S301). If the amount of power harvested by the energy harvester 32 exceeds the amount of power required by the amplifier 31 (step S301: YES), the switch control unit 42 performs control so that the output of the switch 41p and the input of the switch 41q are both on the B side, and power is supplied from the storage battery 33 to the amplifier 31 while causing the energy harvester 32 to charge the storage battery 33 (step S302).

On the other hand, if the amount of power harvested by the energy harvester 32 does not exceed the required power amount of the amplifier 31 (step S301: NO), the switch control unit 42 determines whether or not the amount of power harvested by the energy harvester 32 is equal to or greater than a predetermined threshold (step S303). If the amount of power harvested by the energy harvester 32 is equal to or greater than the predetermined threshold (step S303: YES), the switch control unit 42 performs control so that the output of the switch 41p and the input of the switch 41q are both on the A side, and power is directly supplied from the energy harvester 32 to the amplifier 31 (step S304). That is, if there is no surplus power but the amount of power harvested by the energy harvester 32 is sufficient to supply power to the amplifier 31, the switch control unit 42 causes the energy harvester 32 to directly supply power to the amplifier 31.

On the other hand, if the amount of power harvested by the energy harvester 32 is less than the predetermined threshold (step S303: NO), the switch control unit 42 determines whether or not the amount of power stored in the storage battery 33 is equal to or greater than the predetermined threshold (step S305). If the amount of power stored in the storage battery 33 is equal to or greater than the predetermined threshold (step S305: YES), the switch control unit 42 performs control so that both the output of the switch 41p and the input of the switch 41q to are on the B side, and power is supplied from the storage battery 33 to the amplifier 31 (step S306).

On the other hand, if the amount of power stored in the storage battery 33 is less than the predetermined threshold (step S305: NO), the switch control unit 42 performs control so that the output of the switch 41p and the input of the switch 41q are both on the A side, and power is directly supplied from the energy harvester 32 to amplifier 31 (step S307).

The reason why the switch control unit 42 operates as in step S307 above is that, when the amount of power harvested by the energy harvester 32 is not sufficient to supply power to the amplifier 31, and the amount of power stored in the storage battery 33 is also not sufficient to supply power to the amplifier 31, taking the path through the storage battery 33 causes a further power shortage due to conversion loss. Therefore, the switch control unit 42 performs control so that even a small amount of power harvested is directly supplied to the amplifier 31.

As described above, in the optical power supply system 1b according to the third embodiment, the storage battery 33 and the storage battery use switching unit 40 (first switching unit) are installed in the middle of the path between the amplifier 31 and the energy harvester 32. With such a configuration, the optical power supply system 1b can perform control so that power from the storage battery 33 is supplied to the amplifier 31 while power is stored in the storage battery 33 when the amount of power harvested by the energy harvester 32 exceeds the amount of power required by the amplifier 31, and there is surplus power, and perform control so that power is supplied directly from the energy harvester 32 to the amplifier 31 when the amount of power harvested by the energy harvester 32 does not exceed the amount of power required by the amplifier 31, and there is no surplus power. As a result, the optical power supply system 1b according to the third embodiment can more stably supply energy to the amplifier 31 compared to the optical power supply system 1 according to the first embodiment and the optical power supply system 1a according to the second embodiment.

### Fourth Embodiment

A fourth embodiment of the present invention will be described below.

### [Configuration of Optical Power Supply System]

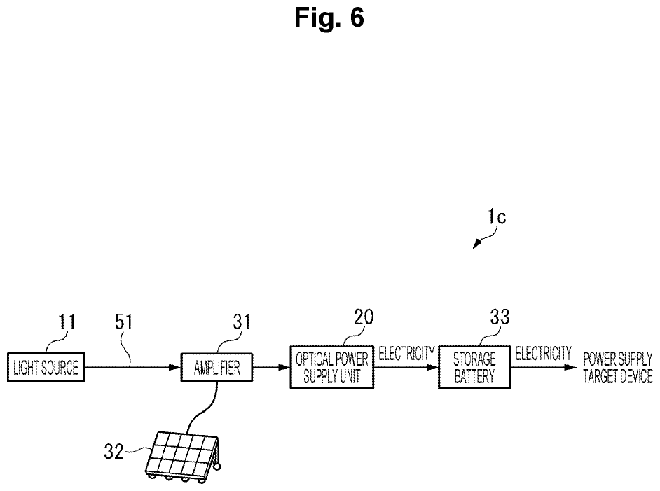

In the following, a configuration of an optical power supply system 1c according to a fourth embodiment will be described. FIG. 6 is the overall configuration diagram of an optical power supply system 1c according to the fourth embodiment of the present invention. As illustrated in FIG. 6, the optical power supply system 1c includes a light source 11, an optical power supply unit 20, an amplifier 31, an energy harvester 32, a storage battery 33, and an optical power supply line 51.

The configuration of the optical power supply system 1c according to the fourth embodiment differs from the configuration of the optical power supply system 1 according to the first embodiment described above in that the storage battery 33 is installed at a subsequent stage of the optical power supply unit 20. The storage battery 33 stores electricity output from the optical power supply unit 20. Then, the storage battery 33 constantly outputs a certain amount of power to the power supply target device in the power supply target area.

With such a configuration, the optical power supply system 1c according to the fourth embodiment can stably supply power to the power supply target device even if the amount of power harvested by the energy harvester 32 varies with time due to environmental changes or the like.

### Fifth Embodiment

A fifth embodiment of the present invention will be described below.

### [Configuration of Optical Power Supply System]

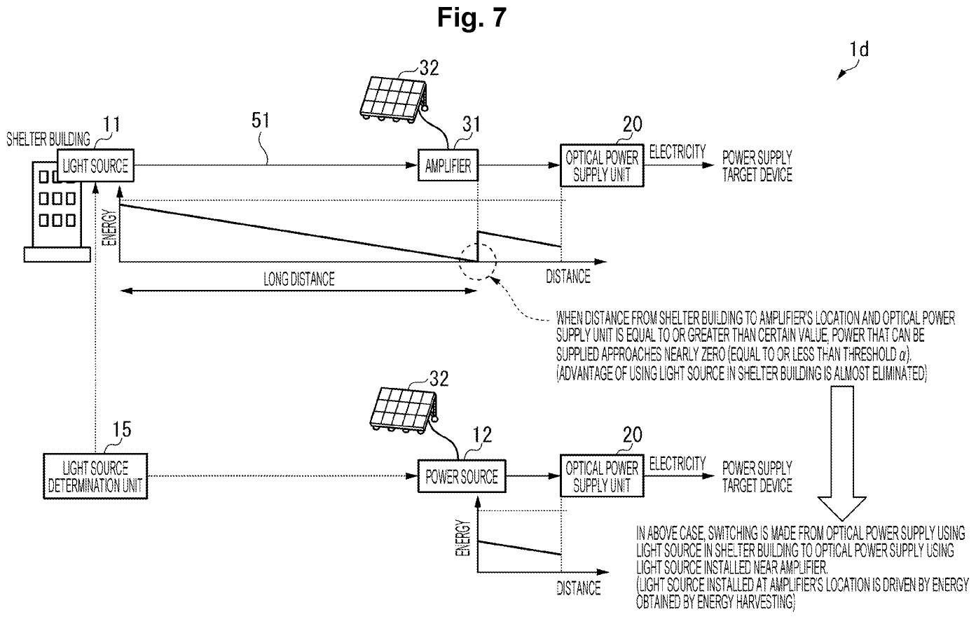

In the following, a configuration of an optical power supply system 1d according to a fifth embodiment will be described. FIG. 7 is a diagram illustrating the overall configuration of the optical power supply system 1d according to the fifth embodiment of the present invention and the amount of energy within an optical fiber. As illustrated in FIG. 7, the optical power supply system 1d includes a light source 11 provided in the shelter building, a light source 12 installed near the energy harvester 32, a light source determination unit 15, an optical power supply unit 20, an amplifier 31, an energy harvester 32, and an optical power supply line 51.

The configuration of the optical power supply system 1d according to the fifth embodiment differs from the configuration of the optical power supply system 1 according to the first embodiment described above in that the light source (light source 12) is also installed near the energy harvester 32, and the light source determination unit 15 is further included. The light source determination unit 15 determines whether to perform optical power supply with the light source 11 or optical power supply with the light source 12.

When the distance between the light source 11 and the optical power supply unit 20 provided in the shelter building is equal to or greater than a certain value, the amount of energy supplied from the light source 11 attenuates to nearly zero (equal to or less than a predetermined threshold α) at the location of the optical power supply unit 20. In this case, the advantage of using the light source 11 provided in the shelter building is almost eliminated.

As described above, when the amount of energy supplied from the light source 11 attenuates to nearly zero at the location of the optical power supply unit 20, the light source determination unit 15 switches from the optical power supply with the light source 11 provided in the shelter building to the optical power supply with the light source 12 installed near the energy harvester 32. Note that the light source 12 is driven by power harvested by the energy harvester 32. This makes it possible to cause the light source 12 to emit light even in a non-electrified area.

With such a configuration, the optical power supply system 1d according to the fifth embodiment can enhance the amount of power supplied without compromising safety in optical power supply even if the distance between the light source 11 and the optical power supply unit 20 provided in the shelter building is equal to or greater than a certain value.

### Sixth Embodiment

A sixth embodiment of the present invention will be described below.

### [Configuration of Optical Power Supply System]

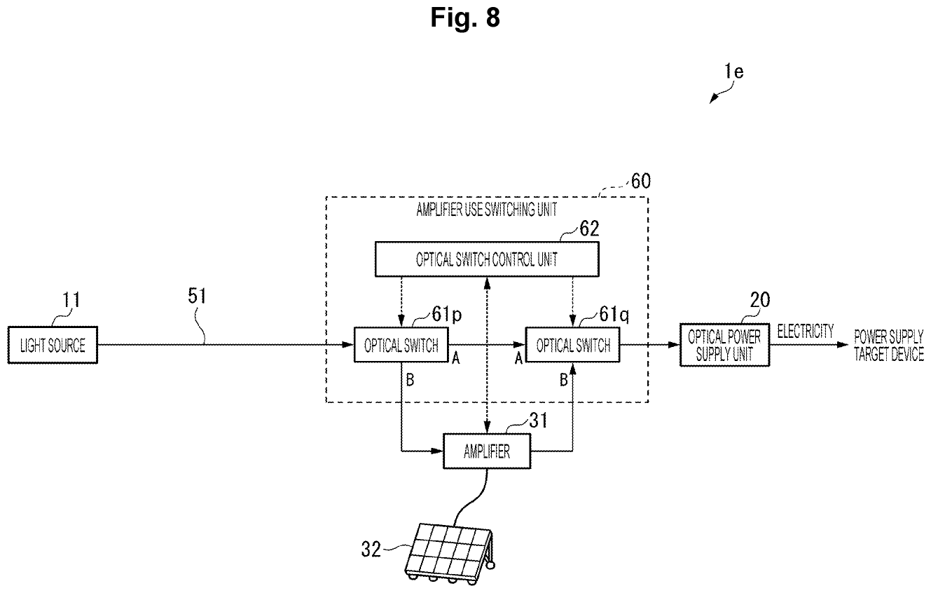

In the following, a configuration of an optical power supply system 1e according to the sixth embodiment will be described. FIG. 8 is the overall configuration diagram of an optical power supply system 1e according to a sixth embodiment of the present invention. As illustrated in FIG. 8, the optical power supply system 1e includes a light source 11, an optical power supply unit 20, an amplifier 31, an energy harvester 32, an optical power supply line 51, and an amplifier use switching unit 60.

The configuration of the optical power supply system 1e according to the sixth embodiment differs from the configuration of the optical power supply system 1 according to the first embodiment described above in that the amplifier use switching unit 60 (second switching unit) is further installed in the middle of the path of the optical power supply line 51. As illustrated in FIG. 8, the amplifier use switching unit 60 includes an optical switch 61p, an optical switch 61q, and an optical switch control unit 62.

The optical switch 61p is a one-input, two-output optical switch and can appropriately switch an output terminal to be used out of the two output terminals. On the other hand, the optical switch 61q is installed at a subsequent stage of the optical switch 61p. The optical switch 61q is a two-input, one-output optical switch and can appropriately switch an input terminal to be used out of the two input terminals. The optical switch control unit 62 controls the switching of the terminals by the optical switch 61p and the optical switch 61q according to the amount of energy amplifiable by the amplifier 31.

As illustrated in FIG. 8, when the output of the optical switch 61p is switched to the A side, and the input of the optical switch 61q is switched to the A side, the light source 11 and the optical power supply unit 20 are directly connected not through the amplifier 31. That is, the light transmitted from the light source 11 is received by the optical power supply unit 20 as it is. When the output of the optical switch 61p is switched to the B side, and the input of the optical switch 61q is switched to the B side, the light source 11 and the optical power supply unit 20 are connected through the amplifier 31. That is, the light transmitted from the light source 11 is amplified by the amplifier 31 and then received by the optical power supply unit 20.

The optical switch control unit 62 checks the amount of energy amplifiable by the amplifier 31 at the current time, and controls the optical switch 61p and the optical switch 61q to form a path through the amplifier 31 when the amplifiable amount is equal to or greater than a predetermined threshold β. On the other hand, when the amount of energy amplifiable by the amplifier 31 at the current time is less than the predetermined threshold β, the optical switch control unit 62 controls the optical switch 61p and the optical switch 61q to form a path not through the amplifier 31.

Since the amplifier 31 is driven by the power supplied from the energy harvester 32, there is a possibility that the supply power shortage occurs due to a decrease in the supply power caused by environmental changes or the like. Then, when the amplifier 31 is not driven due to a shortage of supply power from the energy harvester 32, the amplifier 31 functions not as an amplifier but as a strong attenuator. However, with the configuration as described above, the optical power supply system 1e according to the sixth embodiment can switch to the path not through the amplifier 31 when the amplifier 31 is not driven due to a shortage of supply power. This enables the optical power supply system 1e according to the sixth embodiment to prevent the influence of the amplifier connection loss caused by the connection of the amplifier 31 to the optical power supply line 51, thereby supplying energy to the optical power supply unit 20 without excessive energy loss.

Power to operate the optical switch 61p and the optical switch 61q may be provided by the energy harvester 32. When power is not supplied to the optical switch 61p and the optical switch 61q, the optical switch 61p and the optical switch 61q are configured to be automatically switched to the A side (i.e., the path not through the amplifier 31 is formed.).

Note that the configurations of the amplifier use switching unit 60 and the amplifier 31 of the optical power supply system 1e according to the sixth embodiment can also be applied to the optical power supply systems according to the first to fifth embodiments described above. In that case, the configuration of the amplifier 31 of the optical power supply system according to each of the whether first to fifth embodiments described above may be replaced with a configuration combining the amplifier use switching unit 60 and the amplifier 31 of the optical power supply system 1e according to the sixth embodiment.

### [Operation of Optical Switch Control Unit]

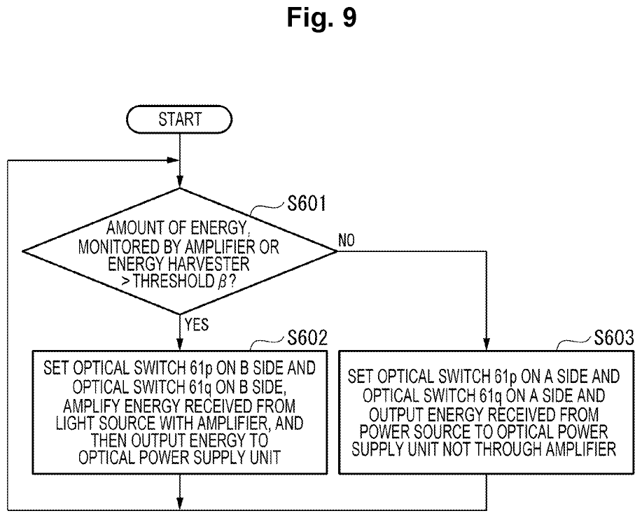

Hereinafter, the operation of the optical switch control unit 62 will be described. FIG. 9 is a flowchart illustrating the operation of the optical switch control unit 62 of the optical power supply system 1e according to the sixth embodiment of the present invention.

The optical switch control unit 62 determines whether or not the amount of energy monitored by the amplifier 31 or the energy harvester 32 exceeds the predetermined threshold β (step S601). If the amount of energy monitored by the amplifier 31 or the energy harvester 32 exceeds the predetermined threshold β (step S601: YES), the optical switch control unit 62 performs control so that the output of the optical switch 61p and the input of the optical switch 61p are both on the B side, and the energy received from the light source 11 is amplified by the amplifier 31 and then supplied to the optical power supply unit 20 (step S602).

On the other hand, if the amount of energy monitored by the amplifier 31 or the energy harvester 32 does not exceed the predetermined threshold β (step S601: NO), the optical switch control unit 62 performs control so that the output of the optical switch 61p and the input of the optical switch 61p are both on the A side, and the energy received from the light source 11 is supplied to the optical power supply unit 20 not through the amplifier 31 (step S603).

As described above, in the optical power supply system 1e according to the sixth embodiment of the present invention, when sufficient power is not supplied to the amplifier 31, the light transmitted from the side is directly transmitted to the optical power supply unit 20 not through the amplifier 31. With such a configuration, according to the optical power supply system 1e, the amplifier 31 can be prevented from working as an attenuator, and the amount of power supplied can be stably enhanced without compromising safety in optical power supply.

### Seventh Embodiment

A seventh embodiment of the present invention will be described below.

### [Configuration of Optical Power Supply System]

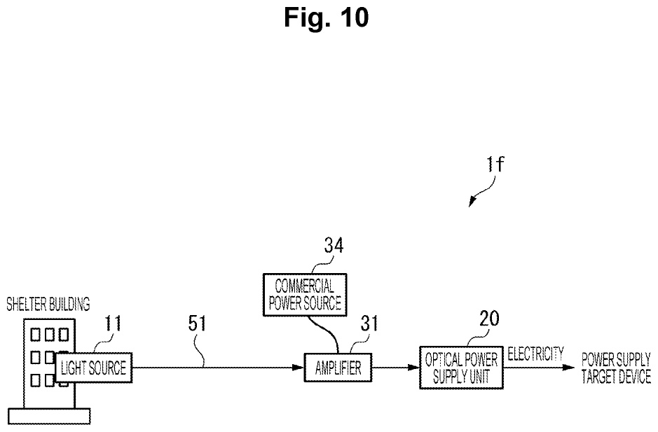

In the following, a configuration of an optical power supply system 1f in the seventh embodiment will be described. FIG. 10 is the overall configuration diagram of the optical power supply system 1f according to the seventh embodiment of the present invention. As illustrated in FIG. 10, the optical power supply system 1f includes a light source 11, an optical power supply unit 20, an amplifier 31, a commercial power source 34, and an optical power supply line 51.

The configuration of the optical power supply system 1f according to the seventh embodiment differs from the configuration of the optical power supply system 1 according to the first embodiment described above in that the commercial power source 34 is used instead of the energy harvester 32. That is, in the seventh embodiment, unlike the first to sixth embodiments described above, it is assumed that the installation location of the amplifier 31 will be in an electrified area rather than a non-electrified area.

In the present embodiment, the amplifier 31 is driven by power supplied from the commercial power source 34. When the installation location of the amplifier 31 is in the electrified area, it is considered possible to install the light source at the installation location of the amplifier 31. However, a large laser is generally used as the light source, and hence the installation of the light source may be difficult due to restrictions on the installation location and restrictions on safety.

As described above, in the optical power supply system 1f according to the seventh embodiment of the present invention, the amplifier 31 is provided in the middle of the path of the optical power supply line 51, which is an optical transmission line connecting the light source 11 and the optical power supply unit 20 that supplies power to the power supply target device. The amplifier 31 amplifies energy to replenish the amount of energy corresponding to the optical fiber loss that occurs in the optical power supply line 51. With such a configuration, the optical power supply system 1f according to the seventh embodiment can supply sufficient power to operate the device in the power supply target area even if, for example, the distance between the light source 11 and the optical power supply unit 20 is long, and the optical fiber loss that occurs in the optical power supply line 51 is large.

### Eighth Embodiment

An eighth embodiment of the present invention will be described below.

### [Configuration of Optical Power Supply System]

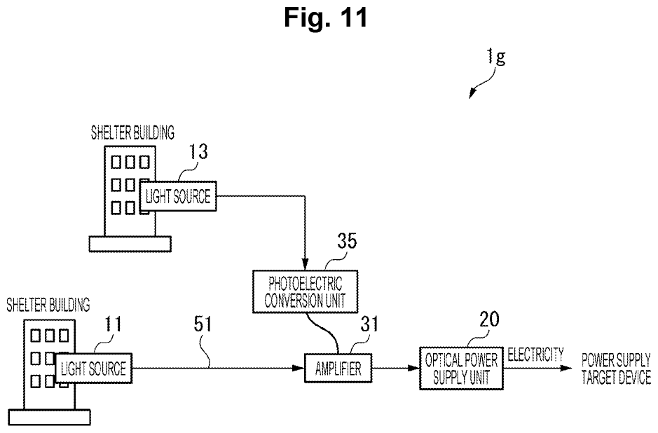

In the following, a configuration of an optical power supply system 1g according to an eighth embodiment will be described. FIG. 11 is the overall configuration diagram of the optical power supply system 1g according to the eighth embodiment of the present invention. As illustrated in FIG. 11, the optical power supply system 1g includes a light source 11, a light source 13, an optical power supply unit 20, an amplifier 31, a photoelectric conversion unit 35, and an optical power supply line 51.

The configuration of the optical power supply system 1f according to the eighth embodiment differs from the configuration of the optical power supply system 1 according to the first embodiment described above in that the light source 13 and the photoelectric conversion unit 35 are used instead of the energy harvester 32.

The light source 13 is installed, for example, in a building such as a shelter building of a communication base station. This shelter building is located in an electrified area and, for example, is located far away from the photoelectric conversion unit 35 and the amplifier 31. The light source 13 transmits light for optical power supply toward the photoelectric conversion unit 35. For example, a continuously illuminated light source may be used for optical power supply. The light transmitted by the light source 13 is transmitted to the photoelectric conversion unit 35 via an optical fiber. For the network configuration of the path between the light source 13 and the photoelectric conversion unit 35, for example, a single-star (SS) configuration without branching is used with the purpose of reducing branching loss.

In this manner, the light source 11 transmits the light designed to operate the power supply target device driven by the optical power supply with the optical power supply unit 20. In contrast, the light source 13 transmits light designed to drive the amplifier 31 to the photoelectric conversion unit 35. The photoelectric conversion unit 35 receives and photoelectrically converts the light transmitted from the light source 13, and supplies power to the amplifier 31 by optical power supply. This drives the amplifier 31.

As described above, in the optical power supply system 1g according to the eighth embodiment of the present invention, the amplifier 31 is provided in the middle of the path of the optical power supply line 51, which is an optical transmission line connecting the light source 11 and the optical power supply unit 20 that supplies power to the power supply target device. The amplifier 31 amplifies energy to replenish the amount of energy corresponding to the optical fiber loss that occurs in the optical power supply line 51. With such a configuration, the optical power supply system 1g according to the eighth embodiment can supply sufficient power to operate the device in the power supply target area even if, for example, the distance between the light source 11 and the optical power supply unit 20 is long, and the optical fiber loss that occurs in the optical power supply line 51 is large.

### EXAMPLES

In the following, the feasibility of the present invention will be clarified by substituting actual values using the configuration of the optical power supply system 1 according to the first embodiment described above as an example.

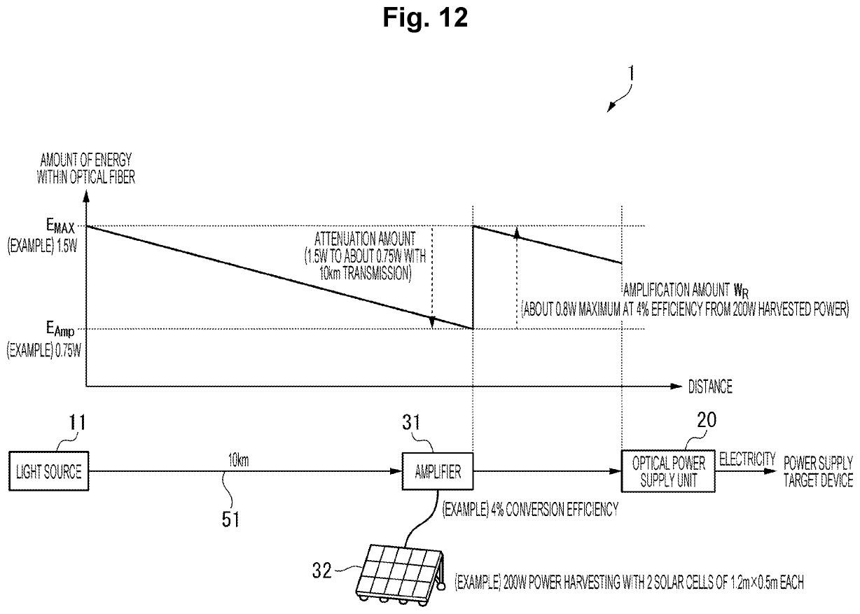

FIG. 12 is a diagram illustrating an example of the present invention. For example, it is assumed that the distance between the light source 11 and the amplifier 31 is 10 [km]. The optical fiber loss that occurs in the optical power supply line 51 is assumed to be 0.3 [dB/km]. From the viewpoint of a fiber fuse phenomenon (a phenomenon in which a fiber melts), when the upper limit of the input optical power is set to 32 [dBm] (=1.5 [W]), the amount of energy within the optical fiber attenuates to 29 [dBm] at the location of the amplifier 31. That is, to compensate for the attenuation of the energy, it is necessary to amplify the energy of 3 [dB] (=0.75 [W]) by the amplifier 31.

For example, the amount of power harvested by two commercially available solar cells, each with dimensions of 1.2 [m]×0.5 [m], is about 200 [W]. Assuming that the average amount of power harvested per day in consideration of nighttime or rainy weather is 1/10 of 200 [W], energy of 20 [W] on average can be supplied from this solar cell. Assuming that the power conversion efficiency in the amplifier 31 is 4 [%], energy of 0.8 [W] can be supplied to the optical fiber. If the amplifier connection loss caused by connecting the amplifier 31 to the optical power supply line 51 is 0.5 [dB] or less, it is theoretically possible to compensate for the energy attenuation (0.75 [W]) described above

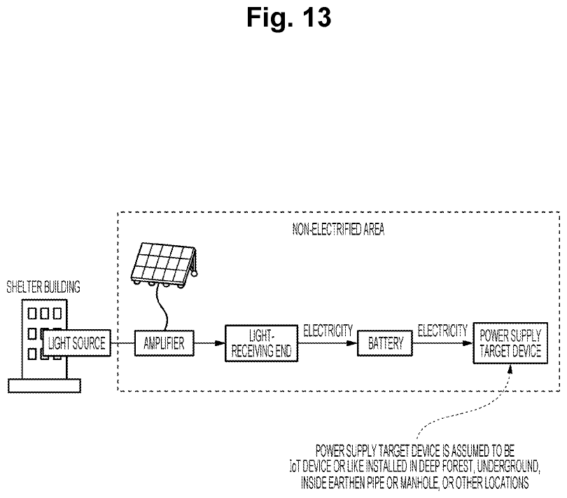

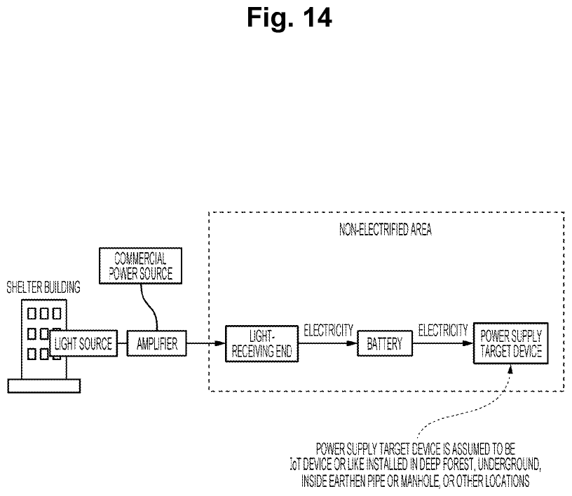

FIGS. 13 and 14 are diagrams illustrating examples of the introduction of the optical power supply systems according to the embodiments of the present invention. FIG. 13 illustrates an example of introduction when the amplifier 31 is installed in a non-electrified area, and FIG. 14 illustrates an example of introduction when the amplifier 31 is installed in an electrified area.

The optical power supply system illustrated in FIG. 13 includes a light source installed in a shelter building in the electrified area, and an amplifier, a light-receiving end, a battery, and a power supply target device in the non-electrified area. Since the amplifier is in the non-electrified area, power to drive the amplifier is supplied by an energy harvester that can harvest power even in the non-electrified area.

On the other hand, the optical power supply system illustrated in FIG. 14 includes a light source and an amplifier installed in a shelter building in an electrified area, and a light-receiving end, a battery, and a power supply target device in a non-electrified area. Since the amplifier is in the electrified area, power to drive the amplifier can be supplied by a commercial power source.

According to the embodiments described above, the optical power supply system includes a light source, an amplifier, and an optical power supply unit. For example, the optical power supply system is one of the optical power supply systems 1, 1a to 1g according to the embodiments, the light source is the light source 11 in the embodiments, the amplifier is the amplifier 31 in the embodiments, and the optical power supply unit is the optical power supply unit 20 in the embodiments. The light source transmits light for optical power supply to an optical power supply line connected to the optical power supply unit. For example, the optical power supply line is the optical power supply line 51 in the embodiments. The amplifier is installed in the middle of the path of the optical power supply line and amplifies the light transmitted from the light source. The optical power supply unit receives the light amplified by the amplifier and photoelectrically converts the light to obtain power.

Note that the optical power supply line may be a line having a single-star configuration.

Note that the optical power supply system may further include an energy harvester. For example, the energy harvester is the energy harvester 32 in the embodiments. The energy harvester 32 harvests electric power by energy harvesting. The amplifier may be driven by electricity acquired from the energy harvester.

Note that the above amplifier may replenish power lost due to optical fiber loss that occurs between the light source and the optical power supply unit.

Note that the above amplifier may replenish the power of the amount of power W_{R} that satisfies the following expression (2).

$${W}_{C} \leq {W}_{R} \leq ( {E}_{MAX} - {E}_{Amp} + {W}_{C} ) \qquad ( 2 )$$

Here, W_{C} represents the amount of power lost when the amplifier is connected to the optical power supply line, E_{MAX} represents the upper limit of power that can be input to the optical power supply line, and E_{Amp} represents the power of the optical power supply line at the location of the amplifier.

Note that the optical power supply system may further include a first switching unit. For example, the first switching unit is the storage battery use switching unit 40 in the embodiment. The first switching unit may switch the path between the energy harvester and the amplifier to either a path through the storage battery or a path not through the storage battery according to the amount of power harvested by the energy harvester. The storage battery is provided between the energy harvester and the amplifier, stores electricity acquired from the energy harvester, and transmits the stored electricity to the amplifier.

Note that the optical power supply system may further include a second switching unit. For example, the second switching unit switches the path between the light source and the optical power supply unit to either a path through the amplifier or a path not through the amplifier according to the amount of power that can be applied by the amplifier.

A part of the configurations of the optical power supply system 1 and the optical power supply systems 1a to 1g according to the embodiments described above may be implemented by a computer. In that case, a program for implementing this function may be recorded in a computer-readable recording medium, and the program recorded in the recording medium may be read and executed by a computer system to implement this function. Note that the “computer system” referred to here includes an operating system (OS) and hardware such as peripheral devices. In addition, the “computer-readable recording medium” refers to a portable medium such as a flexible disk, a magneto-optical disk, a read-only memory (ROM), or a compact disc read-only memory (CD-ROM), or a storage device such as a hard disk built in a computer system. Further, the “computer-readable recording medium” may include a medium that dynamically holds the program for a short period of time, like as a communication line in a case where the program is transmitted via a network such as the Internet or a communication line such as a telephone line, and a medium that holds the program for a certain period of time, like a volatile memory inside a computer system serving as a server or a client in that case. The above program may be for implementing some of the functions described above, may implement the functions described above in combination with the program already recorded in the computer system, or may be implemented by using a programmable logic device such as a field programmable gate array (FPGA).

Although the embodiments of the present invention have been described in detail with reference to the drawings, specific configurations are not limited to the embodiments and include design and the like without departing from the gist of the present invention.

### REFERENCE SIGNS LIST

1, 1a to 1g Optical power supply system
11 to 13 Light source
15 Light source determination unit
20 Optical power supply unit
31 Amplifier
32 Energy harvester
33 Storage battery
34 Commercial power source
35 Photoelectric conversion unit
40 Storage battery use switching unit
41p Switch
41q Switch
42 Switch control unit
51 Optical power supply line
60 Amplifier use switching unit
61p Optical switch
61q Optical switch
62 Optical switch control unit

1. An optical power supply method comprising:
transmitting, by a light source, light for optical power supply to an optical power supply line connected to an optical power supply unit;
amplifying, by an amplifier installed in a middle of a path of the optical power supply line, the light transmitted from the light source; and
receiving, by the optical power supply unit, the light amplified by the amplifier, and photoelectrically converting the light to obtain power.

2. The optical power supply method according to claim 1, wherein
the optical power supply line is a line having a single-star configuration.

3. The optical power supply method according to claim 1, further comprising
harvesting, by an energy harvester, power by energy harvesting, wherein
the amplifier is driven by electricity acquired from the energy harvester.

4. The optical power supply method according to claim 1, wherein
the amplifier replenishes power lost due to optical fiber loss that occurs between the light source and the optical power supply unit.

5. The optical power supply method according to claim 1, wherein
the amplifier replenishes power of an amount of power W_{R} that satisfies an expression below:
$${W}_{C} \leq {W}_{R} \leq ( {E}_{MAX} - {E}_{Amp} + {W}_{C} )$$
where W_{C} represents an amount of power lost due to connection of the amplifier to the optical power supply line, E_{MAX} represents an upper limit of power inputtable to the optical power supply line, and E_{Amp} represents power of the optical power supply line at a location of the amplifier.

6. The optical power supply method according to claim 3, further comprising
switching, by a first switching unit, a path between the energy harvester and the amplifier to one of a path through a storage battery or a path not through the storage battery according to an amount of power harvested by the energy harvester, wherein
the storage battery is provided between the energy harvester and the amplifier, stores electricity acquired from the energy harvester, and transmits the stored electricity to the amplifier.

7. The optical power supply method according to claim 1, further comprising
switching, by a second switching unit, a path between the light source and the optical power supply unit to one of a path through the amplifier or a path not through the amplifier according to an amount of power amplifiable by the amplifier.

8. An optical power supply system comprising:
a light source configured to transmit light for optical power supply to an optical power supply line connected to an optical power supply unit;
an amplifier that is installed in a middle of a path of the optical power supply line and configured to amplify light transmitted from the light source; and
the optical power supply unit configured to receive the light amplified by the amplifier and photoelectrically converts the light to obtain power.
